(19) United States
(12) Patent Application Publication
(10) Pub. No.: US 2022/0228381 A1
(43) Pub. Date: Jul. 21, 2022

(54) COMBINED PREFABRICATED REINFORCED CONCRETE STAIR MOLD AND SPLICING METHOD

(71) Applicants: Zhejiang University, Zhejiang (CN); The Architectural Design & Research Institute of Zhejiang University Co., Ltd., Hangzhou City (CN)

(72) Inventors: Benyue LI, Hangzhou (CN); Quanbiao XU, Hangzhou (CN); Mingshan ZHANG, Hangzhou (CN); Zhibin XIAO, Hangzhou (CN); Jiayin YANG, Hangzhou (CN); Liang XIA, Hangzhou (CN); Kepeng CHEN, Hangzhou (CN); Tao HONG, Hangzhou (CN); Minwei CHEN, Hangzhou (CN)

(73) Assignees: Zhejiang University, Zhejiang (CN); The Architectural Design & Research Institute of Zhejiang University Co., Ltd., Hangzhou City (CN)

(21) Appl. No.: 17/569,224

(22) Filed: Jan. 5, 2022

(30) Foreign Application Priority Data
Jan. 21, 2021 (CN) 202110079591.6

(51) Int. Cl. E04G 13/06; E04G 17/04; E04G 17/00

(52) U.S. Cl. CPC E04G 13/062; E04G 17/001; E04G 17/042

(57) ABSTRACT

The present disclosure provides a combined prefabricated reinforced concrete stair mold and a splicing method. The combined prefabricated reinforced concrete stair mold comprises a bottom mold platform (1), wherein an upper platform module (2), a tread module (3) and a lower platform module (4) which are spliced with one another are sequentially arranged on the upper surface of the bottom mold platform (1), and corner modules (5) are arranged between the upper platform module (2) and the tread module (3) and between the tread module (3) and the lower platform module (4); the tread module (3) comprises a tread upper surface mold (6) and a tread lower surface mold (7); and the tread lower surface mold (7) comprises a plurality of combined templates (8) formed by mutual splicing, and the tread upper surface mold (6) comprises a plurality of tread splicing pieces (9) formed by mutual splicing.

### CROSS REFERENCE TO RELATED APPLICATION(S)

This patent application claims the benefit and priority of Chinese Patent Application No. 202110079591.6, filed on Jan. 21, 2021, the disclosure of which is incorporated by reference herein in its entirety as part of the present application.

### FIELD

The present disclosure relates to a prefabricated reinforced concrete stair mold, in particular to a combined prefabricated reinforced concrete stair mold and a splicing method.

### BACKGROUND

Along with the advancement of building industrialization, more and more building components need to be machined in a factory and are hoisted and constructed after being transported to the site, so that the problems of dust flying, noise pollution and the like in concrete cast-in-place are solved, and the development strategy of green buildings is achieved. Due to frequent size change and various types of stair components, quality control is more difficult when concrete is poured on site, and the stair components become the first choice of prefabricated components for building industrialization.

Even if the stairs are prefabricated in a factory, a series of problems caused by frequent change of the sizes of the stair treads are important to be considered by a production enterprise. At present, for prefabricated stairs with different tread heights and lengths, moulds need to be customized, the mould manufacturing cost is very high, the mould manufacturing period is very long, the production efficiency of factory prefabricated stairs is seriously affected, the factory price of prefabricated components is very high, the popularization of prefabricated stair products is not facilitated, and the implementation of national green building development strategies is not facilitated. The customized prefabricated stair mold is very poor in universality and very low in use efficiency, so that on one hand, material waste is caused, and on the other hand, the construction waste treatment difficulty is increased.

Therefore, the existing technology has the problems of low manufacturing efficiency and high manufacturing cost.

### SUMMARY

The present disclosure aims to provide a combined prefabricated reinforced concrete stair mold and a splicing method. According to the combined prefabricated reinforced concrete stair mold and the splicing method, the characteristics that the manufacturing efficiency is effectively improved and the manufacturing cost is reduced are achieved.

Through the technical scheme of the present disclosure, the combined prefabricated reinforced concrete stair mold comprises a bottom mold platform, wherein an upper platform module, a tread module and a lower platform module which are spliced with one another are sequentially arranged on the upper surface of the bottom mold platform, and corner modules are arranged between the upper platform module and the tread module and between the tread module and the lower platform module; the tread module comprises a tread upper surface mold and a tread lower surface mold; and the tread lower surface mold comprises a plurality of combined templates formed by mutual splicing, and the tread upper surface mold comprises a plurality of tread splicing pieces formed by mutual splicing.

In the combined prefabricated reinforced concrete stair mold, the upper platform module comprises an upper platform end part mold, and an upper platform upper surface mold and an upper platform lower surface mold are arranged on two sides of the upper platform end part mold respectively; and the lower platform module comprises a lower platform end mold, and a lower platform upper surface mold and a lower platform lower surface mold are arranged on two sides of the lower platform end mold respectively.

In the combined prefabricated reinforced concrete stair mold, each of the upper platform upper surface mold, the lower platform upper surface mold, the upper platform lower surface mold and the lower platform lower surface mold comprises one or more combined mold plates formed by splicing.

In the combined prefabricated reinforced concrete stair mold, the combined template comprises a slab, side panels are arranged on two sides of the slab respectively, and a plurality of transverse ribs and vertical ribs located between the two side panels are further arranged on the slab; a plurality of long circular holes are formed in the side panel; and the adjacent combined templates are connected and fixed through bolts.

In the combined prefabricated reinforced concrete stair mold, the tread splicing piece comprises an L-shaped stair block of an inwards-concave structure, connecting plates which are obliquely distributed are arranged at two ends of the L-shaped stair block, and a group of connecting holes are formed in the connecting plate.

In the combined prefabricated reinforced concrete stair mold, an adjusting plate is further arranged between every two adjacent tread splicing pieces, and mounting holes corresponding to the connecting holes are formed in the adjusting plate.

In the combined prefabricated reinforced concrete stair mold, the adjusting plate comprises a plate body, an upper notch slope and/or a lower notch slope are/is arranged at the end part of the plate body, and the inclination angle of the upper notch slope and/or the inclination angle of the lower notch slope correspond/corresponds to the inclination angle of the connecting plate.

In the combined prefabricated reinforced concrete stair mold, the corner module comprises an upper platform upper corner mold located between the tread upper surface mold and the upper platform upper surface mold, a lower platform upper corner mold located between the tread upper surface mold and the lower platform upper surface mold, an upper platform lower corner mold located between the tread lower surface mold and the upper platform lower surface mold and a lower platform lower corner mold located between the tread lower surface mold and the lower platform lower surface mold.

According to a splicing method for realizing a combined prefabricated reinforced concrete stair mold, an upper platform module, a tread module, a lower platform module and corner modules are sequentially fixed to a bottom mold platform according to the shape of a stair, and the method comprises the following steps:

according to the shape and the size of an upper platform of the stair, selecting an upper platform end part mold with a corresponding size, selecting a corresponding number of combined templates to be spliced to form an upper platform upper surface mold and an upper platform lower surface mold, and fixedly installing the upper platform upper surface mold and the upper platform lower surface mold on two sides of the upper platform end part mold to obtain the upper platform module;

according to the shape and the size of a lower platform of the stair, selecting a lower platform end part mold with a corresponding size, selecting a corresponding number of combined templates to be spliced to form a lower platform upper surface mold and a lower platform lower surface mold, and fixedly installing the lower platform upper surface mold and the lower platform lower surface mold on the two sides of the lower platform end part mold to obtain the lower platform module;

according to the shape and size of a tread, selecting a corresponding number of combined templates to be spliced to form a tread lower surface mold; selecting a corresponding number of tread splicing pieces to be spliced to obtain a tread upper surface mold;

connecting the tread upper surface mold with the upper platform module and the lower platform module through an upper platform upper corner mold and a lower platform upper corner mold respectively; and connecting the tread lower surface mold with the upper platform module and the lower platform module through an upper platform lower corner mold and a lower platform lower corner mold respectively.

In the splicing method of the combined prefabricated reinforced concrete stair mold, adjusting plates between the tread splicing pieces are arranged, and the positions of slopes at the end parts of the adjusting plates are controlled, so that the height and/or length, direction and size of the tread are adjusted.

Compared with the prior art, the mold is formed by splicing a plurality of independent modules (an upper platform module, a tread module, a lower platform module and corner modules) with different sizes; a tread lower surface mold, an upper platform upper surface mold, an upper platform lower surface mold, a lower platform upper surface mold and a lower platform lower surface mold of the tread module are formed by splicing one or more combined templates, and the tread upper surface mold is formed by combining and splicing a plurality of tread splicing pieces; the height and/or the length of the stair can be adjusted by arranging the adjusting plates with different notch slopes between the adjacent tread splicing pieces, so that molds of stairs with different tread sizes are generated, the structure is simple, installation is convenient, the manufacturing efficiency of the molds can be effectively improved, all unit molds can be repeatedly used, and then the manufacturing cost can be reduced, and the utilization rate of the unit molds can be improved. In addition, the L-shaped stair blocks of the inwards-concave structures are adopted to form the tread splicing pieces, so that the joints of the tread splicing pieces are located at the upper ends of the treads, the height and the width of the tread can be conveniently adjusted, and the strength of the joints of the treads can be improved. In conclusion, according to the combined prefabricated reinforced concrete stair mold and the splicing method, the characteristics that the manufacturing efficiency is effectively improved and the manufacturing cost is reduced are achieved.

### BRIEF DESCRIPTION OF THE DRAWINGS

FIG. 1 is a stereo view in the present disclosure;

FIG. 2 is a top view in the present disclosure;

FIG. 3 is a structural view of a combined template;

FIG. 4 is a structural view of a tread splicing piece;

FIG. 5 is a structural view of an adjusting plate with an upper notch slope;

FIG. 6 is a structural view after a tread is adjusted in the length direction;

FIG. 7 is an exploded view of FIG. 6;

FIG. 8 is a structural view after a tread is adjusted in the height direction;

FIG. 9 is an exploded view of FIG. 8;

FIG. 10 is a structural view after a tread is adjusted in the length and the height directions; and

FIG. 11 is an exploded view of FIG. 10.

### DETAILED DESCRIPTION OF THE EMBODIMENTS

The present disclosure is further illustrated below in combination with the attached figures and embodiment but not as a basis for the limitation of the present disclosure.

Reference signs in the attached figures: 1, bottom mold platform; 2, upper platform module; 3, tread module; 4, lower platform module; 5, corner module; 6, tread upper surface mold; 7, tread lower surface mold; 8, combined template; 9, tread splicing piece; 10, adjusting plate; 11, mounting hole; 101, plate body; 102, upper notch slope; 103, lower notch slope; 201, upper platform end part mould; 202, upper platform upper surface mold; 203, upper platform lower surface mold; 401, lower platform end part mold; 402, lower platform upper surface mold; 403, lower platform lower surface mold; 501, upper platform upper corner mould; 502, lower platform upper corner mould; 503, upper platform lower corner mould; 504, lower platform lower corner mould; 801, slab; 802, side panel; 803, transverse rib; 804, vertical rib; 805, long circular hole; 901, L-shaped stair block; 902, connecting plate; and 903, connecting hole.

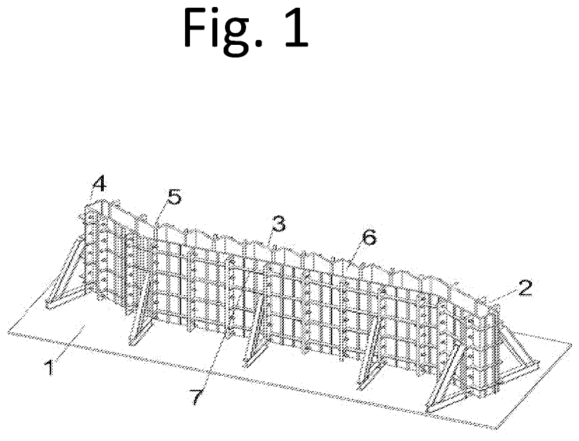

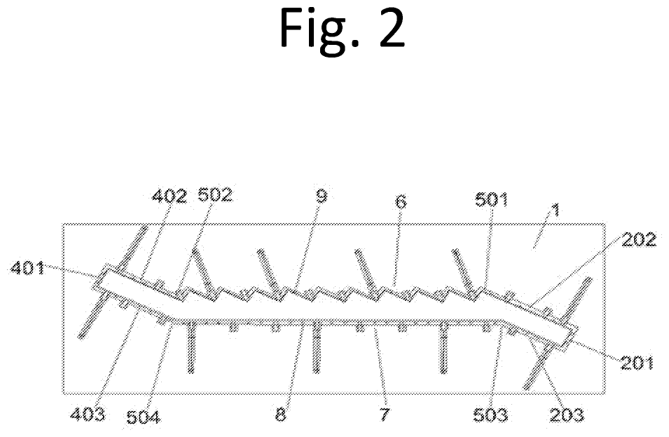

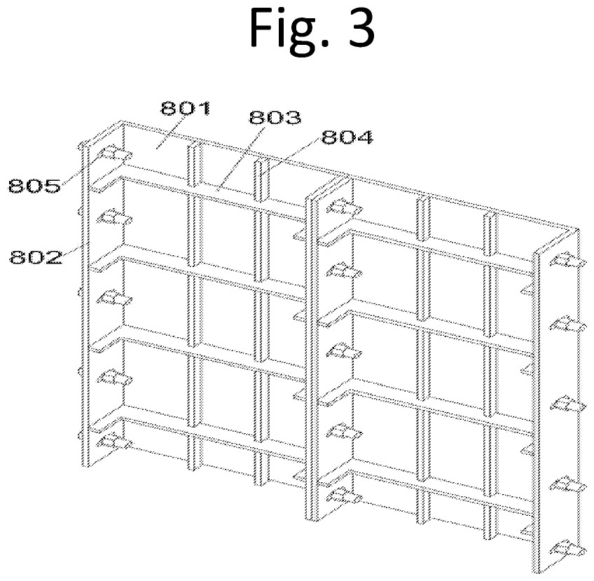

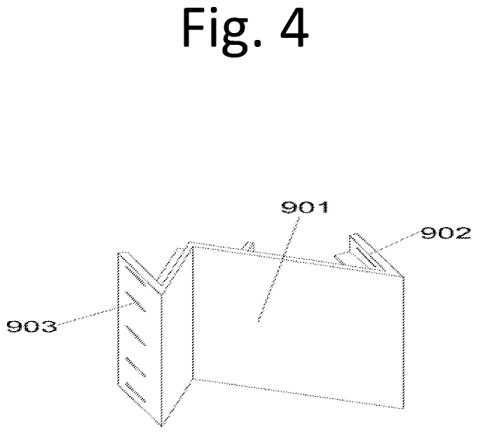

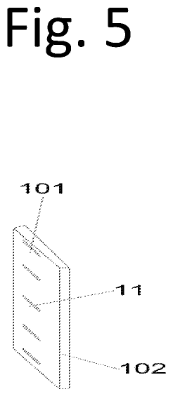

In the embodiment, a combined prefabricated reinforced concrete stair mold, as shown in FIG. 1 to FIG. 11, comprises a bottom mold platform 1, wherein an upper platform module 2, a tread module 3 and a lower platform module 4 which are spliced with one another are sequentially arranged on the upper surface of the bottom mold platform 1, and corner modules 5 are arranged between the upper platform module 2 and the tread module 3 and between the tread module 3 and the lower platform module 4; the tread module 3 comprises a tread upper surface mold 6 and a tread lower surface mold 7; and the tread lower surface mold 7 comprises a plurality of combined templates 8 formed by mutual splicing, and the tread upper surface mold 6 comprises a plurality of tread splicing pieces 9 formed by mutual splicing.

The upper platform module 2 comprises an upper platform end part mold 201, and an upper platform upper surface mold 202 and an upper platform lower surface mold 203 are arranged on two sides of the upper platform end part mold 201 respectively; and the lower platform module 4 comprises a lower platform end mold 401, and a lower platform upper surface mold 402 and a lower platform lower surface mold 403 are arranged on two sides of the lower platform end mold 401 respectively.

Each of the upper platform upper surface mold 202, the lower platform upper surface mold 402, the upper platform lower surface mold 203 and the lower platform lower surface mold 403 comprises one or more combined mold plates 8 formed by splicing.

The combined template 8 comprises a slab 801, side panels 802 are arranged on two sides of the slab 801 respectively, and a plurality of transverse ribs 803 and vertical ribs 804 located between the two side panels 802 are further arranged on the slab 801; a plurality of long circular holes 805 are formed in the side panel 802; and the adjacent combined templates 8 are connected and fixed through bolts.

The tread splicing piece 9 comprises an L-shaped stair block 901 of an inwards-concave structure, connecting plates 902 which are obliquely distributed are arranged at two ends of the L-shaped stair block 901, and a group of connecting holes 903 are formed in the connecting plate 902.

The connecting hole 903 is a long circular hole.

An adjusting plate 10 is further arranged between every two adjacent tread splicing pieces 9, and mounting holes 11 corresponding to the connecting holes 903 are formed in the adjusting plate 10.

The mounting hole is also a long circular hole.

The adjusting plate 10 comprises a plate body 101, an upper notch slope 102 and/or a lower notch slope 103 are/is arranged at the end part of the plate body 101, and the inclination angle of the upper notch slope 102 and/or the inclination angle of the lower notch slope 103 correspond/corresponds to the inclination angle of the connecting plate 902.

The corner module 5 comprises an upper platform upper corner mold 501 located between the tread upper surface mold 6 and the upper platform upper surface mold 202, a lower platform upper corner mold 502 located between the tread upper surface mold 6 and the lower platform upper surface mold 402, an upper platform lower corner mold 503 located between the tread lower surface mold 7 and the upper platform lower surface mold 203 and a lower platform lower corner mold 504 located between the tread lower surface mold 7 and the lower platform lower surface mold 403.

According to a splicing method for realizing a combined prefabricated reinforced concrete stair mold, an upper platform module, a tread module, a lower platform module and corner modules are sequentially fixed to a bottom mold platform according to the shape of a stair, and the method comprises the following steps:

according to the shape and the size of an upper platform of the stair, selecting an upper platform end part mold with a corresponding size, selecting a corresponding number of combined templates to be spliced to form an upper platform upper surface mold and an upper platform lower surface mold, and fixedly installing the upper platform upper surface mold and the upper platform lower surface mold on two sides of the upper platform end part mold to obtain the upper platform module;

according to the shape and the size of a lower platform of the stair, selecting a lower platform end part mold with a corresponding size, selecting a corresponding number of combined templates to be spliced to form a lower platform upper surface mold and a lower platform lower surface mold, and fixedly installing the lower platform upper surface mold and the lower platform lower surface mold on the two sides of the lower platform end part mold to obtain the lower platform module;

according to the shape and size of a tread, selecting a corresponding number of combined templates to be spliced to form a tread lower surface mold; selecting a corresponding number of tread splicing pieces to be spliced to obtain a tread upper surface mold;

connecting the tread upper surface mold with the upper platform module and the lower platform module through an upper platform upper corner mold and a lower platform upper corner mold respectively; and connecting the tread lower surface mold with the upper platform module and the lower platform module through an upper platform lower corner mold and a lower platform lower corner mold respectively.

Adjusting plates between the tread splicing pieces are arranged, and the positions of slopes at the end parts of the adjusting plates are controlled, so that the height and/or length, direction and size of the tread are adjusted.

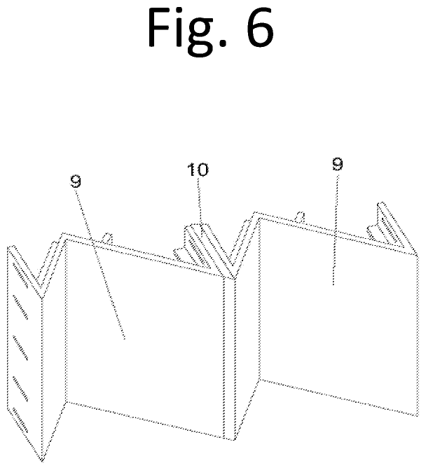

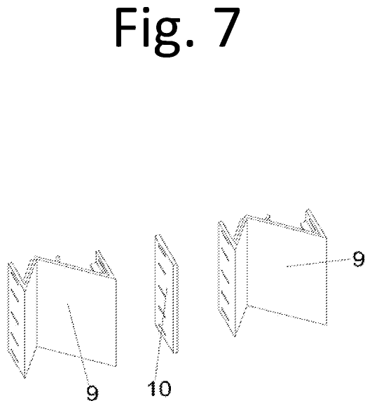

When the adjusting plate with an upper notch slope is used, as shown in FIG. 6 and FIG. 7, the adjusting plate only needs to be placed between two tread splicing pieces, the upper notch slope corresponds to the connecting plate on the upper tread splicing piece, bolts penetrate through the mounting holes and the connecting holes and then are fixed through nuts, and then the length of the tread can be adjusted.

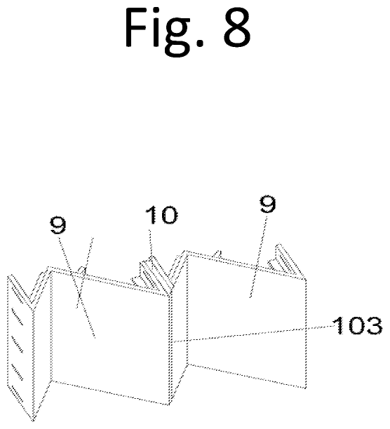

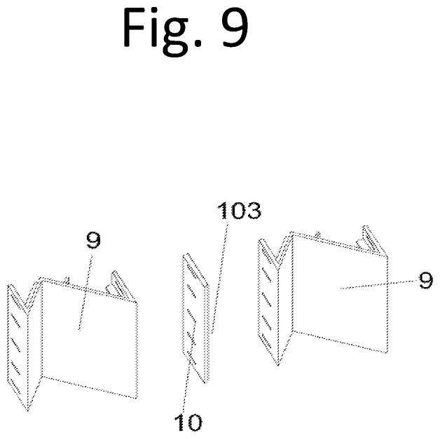

When the adjusting plate with a lower notch slope is used, as shown in FIG. 8 and FIG. 9, the adjusting plate is placed between two tread splicing pieces, the lower notch slope corresponds to the connecting plate on the lower tread splicing piece, bolts penetrate through the mounting holes and the connecting holes and then are fixed through nuts, and then the height of the tread can be adjusted.

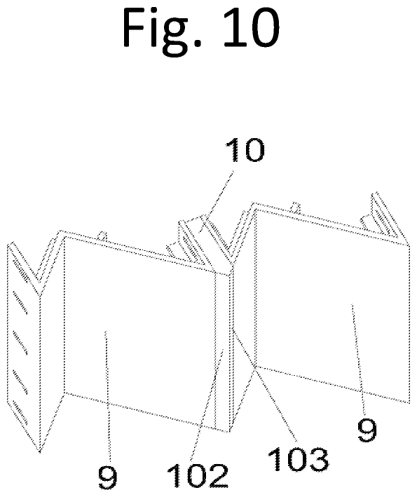

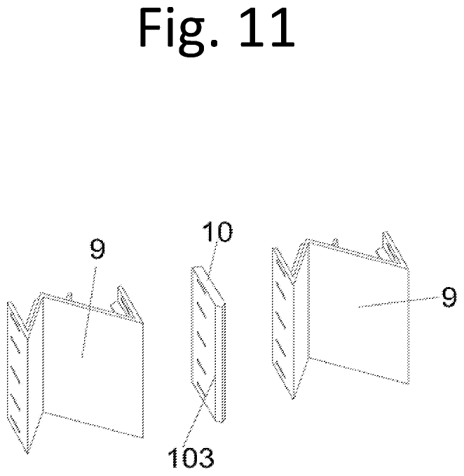

When the adjusting plates with the upper notch slope and the lower notch slope are used, as shown in FIG. 10 and FIG. 11, the adjusting plates are placed between two tread splicing pieces, the upper notch slope corresponds to the connecting plate on the upper tread splicing piece, the lower notch slope corresponds to the connecting plate on the lower tread splicing piece, bolts penetrate through the mounting holes and the connecting holes and then are fixed through nuts, and then the length and the height of the tread can be adjusted.

A plurality of inclined struts are arranged among the upper platform module, the tread module, the lower platform module and the bottom mold platform.

The mold in the present disclosure can be made of steel, aluminum, alloy materials or plastics.

The flatness problem at the joints of all the modules can be solved in modes of gluing and the like.

The joints of the tread splicing pieces are arranged at the upper ends of stairs.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A combined prefabricated reinforced concrete stair mold, comprising:
a bottom mold platform (1), wherein
an upper platform module (2), a tread module (3) and a lower platform module (4), which are spliced with one another, are sequentially arranged on an upper surface of the bottom mold platform (1), and corner modules (5) are arranged between the upper platform module (2) and the tread module (3) and between the tread module (3) and the lower platform module (4);
the tread module (3) comprises a tread upper surface mold (6) and a tread lower surface mold (7); and
the tread lower surface mold (7) comprises a plurality of combined templates (8) formed by mutual splicing, and the tread upper surface mold (6) comprises a plurality of tread splicing pieces (9) formed by mutual splicing.

2. The combined prefabricated reinforced concrete stair mold according to claim 1, wherein
the upper platform module (2) comprises an upper platform end part mold (201), and an upper platform upper surface mold (202) and an upper platform lower surface mold (203) are arranged on two sides of the upper platform end part mold (201) respectively; and
the lower platform module (4) comprises a lower platform end mold (401), and a lower platform upper surface mold (402) and a lower platform lower surface mold (403) are arranged on two sides of the lower platform end mold (401) respectively.

3. The combined prefabricated reinforced concrete stair mold according to claim 2, wherein
each of the upper platform upper surface mold (202), the lower platform upper surface mold (402), the upper platform lower surface mold (203) and the lower platform lower surface mold (403) comprises one or more combined mold plates (8) formed by splicing.

4. The combined prefabricated reinforced concrete stair mold according to claim 1, wherein
the combined template (8) comprises a slab (801), side panels (802) are arranged on two sides of the slab (801) respectively, and a plurality of transverse ribs (803) and vertical ribs (804) located between the two side panels (802) are further arranged on the slab (801);
a plurality of long circular holes (805) are formed in the side panel (802); and
the combined templates (8) are connected and fixed through bolts.

5. The combined prefabricated reinforced concrete stair mold according to claim 3, wherein
the combined template (8) comprises a slab (801), side panels (802) are arranged on two sides of the slab (801) respectively, and a plurality of transverse ribs (803) and vertical ribs (804) located between the two side panels (802) are further arranged on the slab (801);
a plurality of long circular holes (805) are formed in the side panel (802); and
the adjacent combined templates (8) are connected and fixed through bolts.

6. The combined prefabricated reinforced concrete stair mold according to claim 4, wherein
a base plate is arranged between every two adjacent combined templates (8).

7. The combined prefabricated reinforced concrete stair mold according to claim 5, wherein
a base plate is arranged between every two adjacent combined templates (8).

8. The combined prefabricated reinforced concrete stair mold according to claim 1, wherein
the tread splicing piece (9) comprises an L-shaped stair block (901) of an inwards-concave structure, connecting plates (902) which are obliquely distributed are arranged at two ends of the L-shaped stair block (901), and a group of connecting holes (903) are formed in the connecting plate (902).

9. The combined prefabricated reinforced concrete stair mold according to claim 8, wherein
an adjusting plate (10) is further arranged between every two adjacent tread splicing pieces (9), and mounting holes (11) corresponding to the connecting holes (903) are formed in the adjusting plate (10).

10. The combined prefabricated reinforced concrete stair mold according to claim 9, wherein
the adjusting plate (10) comprises a plate body (101), an upper notch slope (102) and/or a lower notch slope (103) are/is arranged at the end part of the plate body (101), and the inclination angle of the upper notch slope (102) and/or the inclination angle of the lower notch slope (103) correspond/corresponds to the inclination angle of the connecting plate (902).

11. The combined prefabricated reinforced concrete stair mold according to claim 2, wherein
the corner module (5) comprises an upper platform upper corner mold (501) located between the tread upper surface mold (6) and the upper platform upper surface mold (202), a lower platform upper corner mold (502) located between the tread upper surface mold (6) and the lower platform upper surface mold (402), an upper platform lower corner mold (503) located between the tread lower surface mold (7) and the upper platform lower surface mold (203) and a lower platform lower corner mold (504) located between the tread lower surface mold (7) and the lower platform lower surface mold (403).

12. A splicing method for realizing a combined prefabricated reinforced concrete stair mold, wherein an upper platform module, a tread module, a lower platform module and corner modules are sequentially fixed to a bottom mold platform according to a shape of a stair, the method comprising:
according to the shape and the size of an upper platform of the stair, selecting an upper platform end part mold with a corresponding size, selecting a corresponding number of combined templates to be spliced to form an upper platform upper surface mold and an upper platform lower surface mold, and fixedly installing the upper platform upper surface mold and the upper platform lower surface mold on two sides of the upper platform end part mold to obtain the upper platform module;
according to the shape and the size of a lower platform of the stair, selecting a lower platform end part mold with a corresponding size, selecting a corresponding number of combined templates to be spliced to form a lower platform upper surface mold and a lower platform lower surface mold, and fixedly installing the lower platform upper surface mold and the lower platform lower surface mold on the two sides of the lower platform end part mold to obtain the lower platform module;
according to the shape and size of a tread, selecting a corresponding number of combined templates to be spliced to form a tread lower surface mold; selecting a corresponding number of tread splicing pieces to be spliced to obtain a tread upper surface mold;
connecting the tread upper surface mold with the upper platform module and the lower platform module through an upper platform upper corner mold and a lower platform upper corner mold respectively; connecting the tread lower surface mold with the upper platform module and the lower platform module through an upper platform lower corner mold and a lower platform lower corner mold respectively;
arranging adjusting plates between the tread splicing pieces, and controlling the positions of slopes at the end parts of the adjusting plates, so that the height and/or length, direction and size of the tread are adjusted; and
arranging cushion plate between the combined templates, so that the thicknesses of the adjacent combined templates are adjusted.

13. The splicing method according to claim 12, wherein
the upper platform module (2) comprises an upper platform end part mold (201), and an upper platform upper surface mold (202) and an upper platform lower surface mold (203) are arranged on two sides of the upper platform end part mold (201) respectively; and the lower platform module (4) comprises a lower platform end mold (401), and a lower platform upper surface mold (402) and a lower platform lower surface mold (403) are arranged on two sides of the lower platform end mold (401) respectively.

14. The splicing method according to claim 13, wherein
each of the upper platform upper surface mold (202), the lower platform upper surface mold (402), the upper platform lower surface mold (203) and the lower platform lower surface mold (403) comprises one or more combined mold plates (8) formed by splicing.

15. The splicing method according to claim 12, wherein
the combined template (8) comprises a slab (801), side panels (802) are arranged on two sides of the slab (801) respectively, and a plurality of transverse ribs (803) and vertical ribs (804) located between the two side panels (802) are further arranged on the slab (801);
a plurality of long circular holes (805) are formed in the side panel (802); and
the adjacent combined templates (8) are connected and fixed through bolts.

16. The splicing method according to claim 15, wherein a base plate is arranged between every two adjacent combined templates (8).

17. The splicing method according to claim 12, wherein the tread splicing piece (9) comprises an L-shaped stair block (901) of an inwards-concave structure, connecting plates (902) which are obliquely distributed are arranged at two ends of the L-shaped stair block (901), and a group of connecting holes (903) are formed in the connecting plate (902).

18. The splicing method according to claim 17, wherein
an adjusting plate (10) is further arranged between every two adjacent tread splicing pieces (9), and mounting holes (11) corresponding to the connecting holes (903) are formed in the adjusting plate (10).

19. The splicing method according to claim 18, wherein
the adjusting plate (10) comprises a plate body (101), an upper notch slope (102) and/or a lower notch slope (103) are/is arranged at the end part of the plate body (101), and the inclination angle of the upper notch slope (102) and/or the inclination angle of the lower notch slope (103) correspond/corresponds to the inclination angle of the connecting plate (902).

20. The splicing method according to claim 13, wherein
the corner module (5) comprises an upper platform upper corner mold (501) located between the tread upper surface mold (6) and the upper platform upper surface mold (202), a lower platform upper corner mold (502) located between the tread upper surface mold (6) and the lower platform upper surface mold (402), an upper platform lower corner mold (503) located between the tread lower surface mold (7) and the upper platform lower surface mold (203) and a lower platform lower corner mold (504) located between the tread lower surface mold (7) and the lower platform lower surface mold (403).
